(19) United States
(12) Patent Application Publication
(10) Pub. No.: US 2012/0154312 A1
(43) Pub. Date: Jun. 21, 2012

(54) TOUCH-SENSITIVE DEVICE AND FABRICATION METHOD THEREOF

(76) Inventors: Ping-Wen HUANG, Tai Chung City (TW); Pheng-Chih Yu, Peng Hu County (TW); Heng-Ting Ke, Chang Hua County (TW); Chun-Hao Wang, Chang Hua County (TW); Yi-Chen Tsai, Tai Chung County (TW); Yu-Min Chen, Tai Chung City (TW); Yi-Wei Wang, Chang Hua City (TW); Chi-Ming Hsieh, Tai Chung City (TW)

(21) Appl. No.: 13/328,034

(22) Filed: Dec. 16, 2011

(30) Foreign Application Priority Data
Dec. 21, 2010 (TW) 099144917

(51) Int. Cl. G06F 3/041; H01H 11/00

(52) U.S. Cl. 345/173; 29/622

(57) ABSTRACT

A touch-sensitive device includes a transparent substrate, a decorative layer, and a touch-sensing electrode layer. The decorative layer is disposed on the transparent substrate, and a notch is formed on the decorative layer at a position substantially coinciding with a distribution area of an icon formed on a non-screen area. The touch-sensing electrode layer includes a plurality of first transparent electrodes, second transparent electrodes and connecting lines. Each connecting line connects two adjacent first transparent electrodes or two adjacent second transparent electrodes and does not overlap a periphery of the notch.

### BACKGROUND OF THE INVENTION

a. Field of the Invention

The invention relates a touch-sensitive device and a fabrication method of the touch-sensitive device.

b. Description of the Related Art

In a typical design of a capacitive touch-sensitive device, a distribution area of a touch sensor may extend into a non-screen area on which an icon is formed. For example, as shown in FIG. 5A and FIG. 5B, a decorative layer 102 is formed on a transparent substrate 100, and a portion of the decorative layer 102 is hollowed out to form a notch 106 that coincides with a distribution area of the icon 104. However, when a portion of the decorative layer 102 is hollowed out to form the notch 106, a steep drop is formed on the periphery of the notch 106. Therefore, when a connecting line 108 that connects transparent electrodes is formed on the decorative layer 102 and overlaps the periphery of the notch 106 (i.e., the connecting line 108 crosses the contour of the icon 104), the connecting line 108 has to climb the steep drop to considerably raise the possibility of breaking the connecting 108. This may cause short-circuit or open-circuit of the connection wiring to result in inferior electrical properties and lower production yield and reliability of finished products.

### BRIEF SUMMARY OF THE INVENTION

The invention provides a touch-sensitive device and its fabrication method having high production yields and reliability.

In order to achieve one or a portion of or all of the objects or other objects, one embodiment of the invention provides a touch-sensitive device having a screen area and a non-screen area. At least one icon is formed on the non-screen area, and the touch-sensitive device includes a transparent substrate, a decorative layer, and a touch-sensing electrode layer. The decorative layer is disposed on the transparent substrate, and a notch is formed on the decorative layer at a position substantially coinciding with a distribution area of the icon. The touch-sensing electrode layer is disposed on the transparent substrate and includes a plurality of first transparent electrodes, second transparent electrodes and connecting lines. Each of the connecting lines connects two adjacent first transparent electrodes or two adjacent second transparent electrodes and does not overlap a periphery of the notch.

According to another embodiment of the invention, a fabrication method of a touch-sensitive device includes the steps of providing a transparent substrate, forming a decorative layer on the transparent substrate, forming a notch on the decorative layer at a position substantially coinciding with a distribution area of an icon, and forming a plurality of connecting lines that connect transparent electrodes on the transparent substrate, where the connecting lines on the decorative layer do not overlap a periphery of the notch.

According to another embodiment of the invention, a fabrication method of a touch-sensitive device includes the steps of providing transparent substrate, arranging a plurality of connecting lines that connect transparent electrodes in predetermined positions of the transparent substrate, detecting whether or not the predetermined positions cross the contour of an icon, labeling a connecting line crossing the contour of the icon as a connecting line to be adjusted, and moving or rotating the connecting line to be adjusted to prevent all the connecting lines on the transparent substrate from crossing the contour of the icon.

In one embodiment, the decorative layer includes at least one of diamond like carbon, ceramic, colored ink, resin and photo resist.

In one embodiment, each of the connecting lines includes at least one of a metallic material, a polymeric conductive material, ITO, IZO, AZO, ZnO and SnO.

According to the above embodiments, the contour of each icon is allowed to avoid crossing connecting lines that connect transparent electrodes. Therefore, the connecting lines do not overlap a periphery of the notch and thus need not to climb the steep drop to considerably decrease the possibility of breaking the connecting lines. As a result, the problem of inferior electrical properties existing in subsequent fabrication processes is avoided to improve production yield and reliability of finished products.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram of a touch-sensitive device according to an embodiment of the invention, FIG. 2A shows a partial enlarged diagram of the touch-sensitive device shown in FIG. 1, and FIG. 2B shows a cross-section cut along line A-A′ of FIG. 2A.

FIG. 3 shows a schematic diagram of a touch-sensitive device according to another embodiment of the invention.

FIG. 4A and FIG. 4B show schematic diagrams of a touch-sensitive device according to another embodiment of the invention.

FIG. 5A shows a partial enlarged diagram of a conventional touch-sensitive device, and FIG. 5B shows a cross-section cut along line B-B′ of FIG. 5A.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

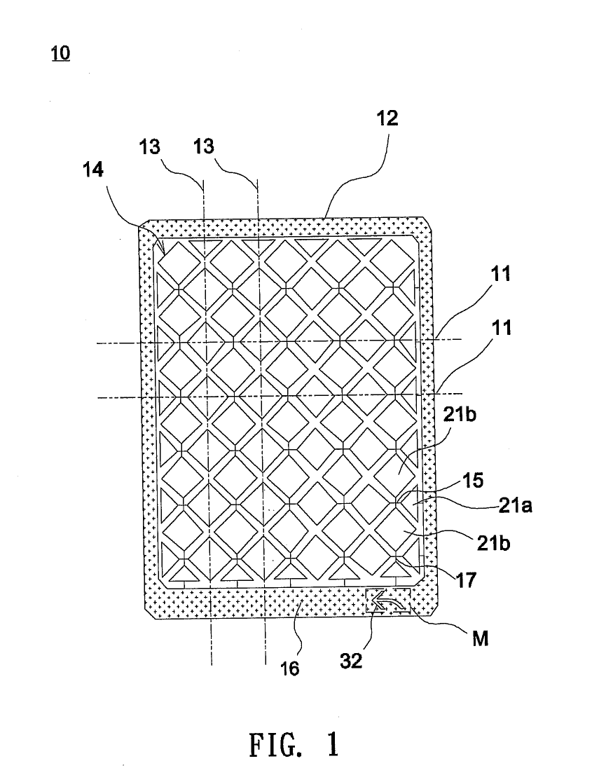

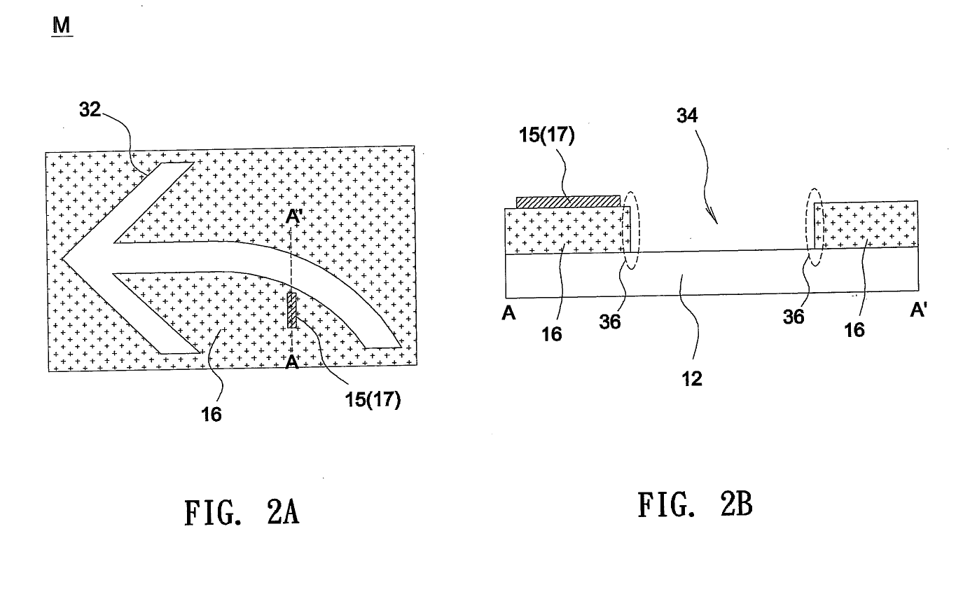

FIG. 1 shows a schematic diagram of a touch-sensitive device 10 according to an embodiment of the invention, FIG. 2A shows a partial enlarged diagram of the touch-sensitive device 10 shown in FIG. 1, and FIG. 2B shows a cross-section M cut along line A-A′ of FIG. 2A. Referring to FIG. 1, FIG.2A and FIG.2B, in the touch-sensitive device 10, a touch-sensing electrode layer 14 and a decorative layer 16 are disposed on a transparent substrate 12. The touch-sensing electrode layer 14 may include a plurality of first sensing series 11 and a plurality of second sensing series 13 spaced apart from the first sensing series 11. Each first sensing series 11 includes multiple first transparent electrodes 21a connected with each other by multiple first connecting lines 15, and each second sensing series 13 includes multiple second transparent electrodes 21b connected with each other by multiple second connecting lines 17. The first transparent electrodes 21a and the second transparent electrodes 21b may be, but not limited to, in the shape of a diamond, a triangle, or a line segment. In this embodiment, the touch-sensitive device 10 may be divided into a screen area and a non-screen area, and the decorative layer 16 substantially overlaps the non-screen area. The screen area is for the purpose of showing images, text or graphics that may be from a display. The touch-sensing electrode layer 14 is mainly distributed in the screen area and may, in this embodiment, extend to the non-screen area on which at least one icon 32 is formed. The icon 32 may serve different functions of marking a touch-sensitive key, recognizing a brand image, etc. When the icon 32 is designed to be disposed in the non-screen area (hatched lines shown in FIG. 1), a portion of the decorative layer 102 in the non-screen area corresponding to a distribution area of the icon 32 has to be hollowed out to form a notch 34. In other words, a distribution area of the notch 34 substantially coincides with the distribution area of the icon 32. However, the notch 34 formed on the decorative layer 16 results in a steep drop on the periphery 36 of the notch 34. Therefore, in case the connecting lines 15 and 17 are formed to overlap the periphery 36 of the notch 34 (at least one part of the connecting lines 15 and 17 crosses the contour of the icon 32), at least one of the connecting lines 15 and 17 have to climb the steep drop to considerably raise the possibility of breaking the connecting lines and result in disconnection between two adjacent first transparent electrodes 21a or between two second transparent electrodes 21b. As can be clearly seen in FIG. 2A and FIG. 2B, according to the above embodiment, the connecting lines 15 and 17 do not overlap the periphery 36 of the notch 34; in other words, the connecting lines 15 and 17 do not cross the contour of the icon 32. More specifically, as shown in FIG. 3, multiple icons 32, 36 and 38 are formed in the non-screen area of the decorative layer 16, where the contour of the icon 32 formed in a predetermined position P crosses the connecting line 15 or the connecting line 17. In that case, by moving the icon 32 for a distance d (such as 0.3 mm) from the predetermined position P to another position Q, the contour of the icon 32 is allowed to avoid crossing the connecting line 15 or the connecting line 17. Therefore, the connecting lines 15 and 17 do not overlap the periphery 36 of the notch 34 and thus need not to climb the steep drop to considerably decrease the possibility of breaking the connecting lines 15 and 17. As a result, the problem of inferior electrical properties existing in subsequent fabrication processes is avoided to improve production yield and reliability of finished products.

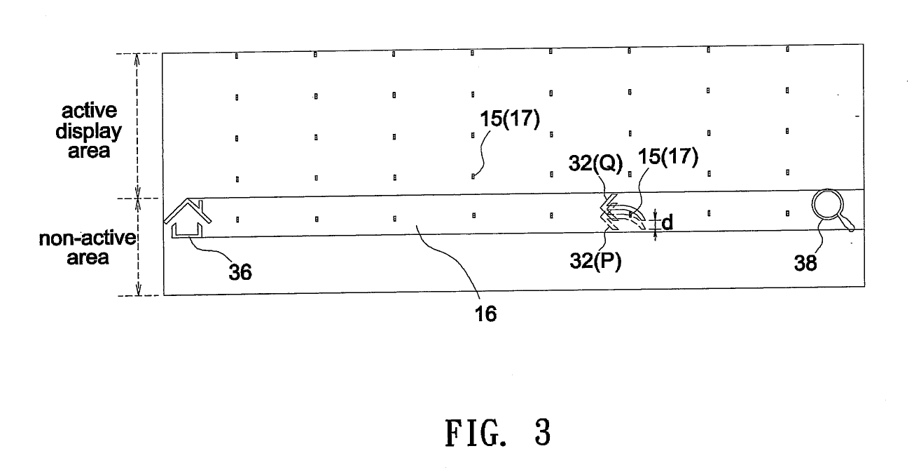

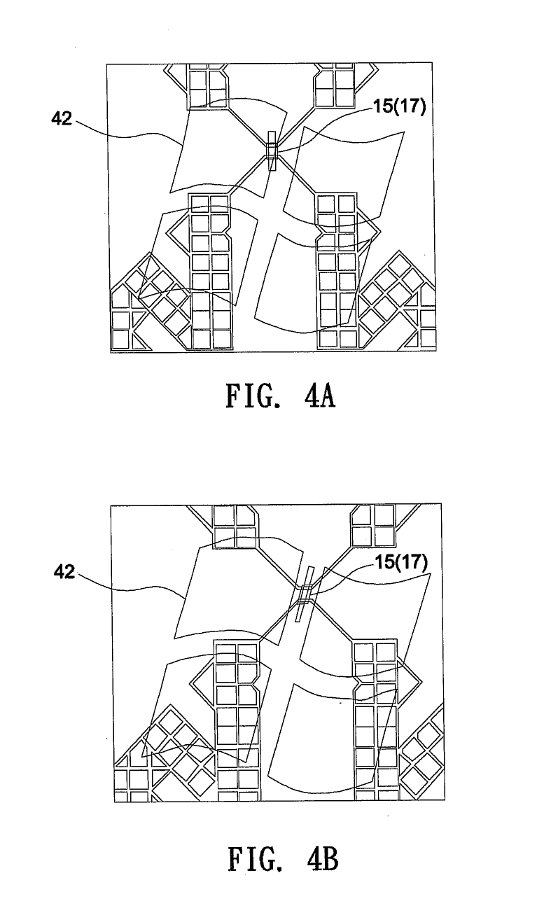

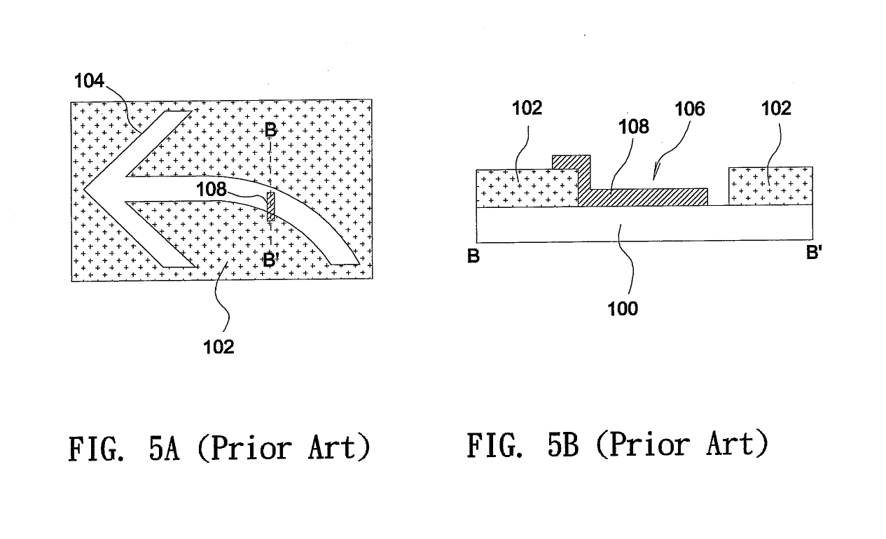

In an alternate embodiment, in case the contour of an icon 42 (exemplified as a “WINDOW” trademark) crosses the connecting line 15 or the connecting line 17 as shown in FIG. 4A, the connecting line 15 or the connecting line 17 may rotate to change its position to allow the contour of an icon 42 to avoid crossing the connecting line 15 or the connecting line 17, as shown in FIG. 4B. In one embodiment, the connecting line 17 may rotate an angle relative to the connecting line 15 that crosses the connecting line 17 to avoid crossing the contour of the icon 42. Further, the included angle between the rotatable connecting line 17 and the connecting line 15 may be in the range of 0 degree to 90 degrees. Besides, part of the second transparent electrodes 21b may also shift a distance (shown in FIG. 4B) from the original position (shown in FIG. 4A) to match the rotatable connecting line 17 and the connecting line 15.

Therefore, according to an embodiment of the invention, a fabrication method of a touch-sensitive device is provided below. When a touch-sensing electrode layer 14 and a decorative layer 16 are formed on a transparent substrate 12, a notch 34 is formed on the decorative layer 16 and substantially coincides with a distribution area of an icon 32, and the contour of the icon 32 does not cross the connecting lines 15 and 17. That is, the connecting lines 15 and 17 do not overlap the periphery 36 of the notch 34. Alternatively, in case the predetermined positions of regularly-arranged connecting lines 15 and 17 cross the contour of an icon 42 on the decorative layer 16, the connecting lines 15 and 17 are labeled as connecting lines to be adjusted, and then the connecting lines to be adjusted are moved or rotated to prevent all the connecting lines on the transparent substrate 12 from crossing the contour of the icon 42.

In one embodiment, the decorative layer 16 may be a shelter layer, a colored layer or a transparent layer. Further, the decorative layer 16 may include at least one of diamond like carbon, ceramic, colored ink, resin and photo resist. The connecting lines 15 and 17 may be made of a transparent conductive material or a metallic material, and the transparent conductive material may include at least one of polymeric conductive material, ITO, IZO, AZO, ZnO and SnO.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

What is claimed is:

1. A touch-sensitive device having a screen area and a non-screen area, wherein at least one icon is formed on the non-screen area, the touch-sensitive device comprising:
a transparent substrate;
a decorative layer disposed on the transparent substrate, wherein a notch is formed on the decorative layer at a position substantially coinciding with a distribution area of the icon; and
a touch-sensing electrode layer disposed on the transparent substrate and comprising a plurality of first transparent electrodes, second transparent electrodes and connecting lines, wherein each of the connecting lines connects two adjacent first transparent electrodes or two adjacent second transparent electrodes and does not overlap a periphery of the notch.

2. The touch-sensitive device as claim in claim 1, wherein the decorative layer comprises at least one of diamond like carbon, ceramic, colored ink, resin and photo resist.

3. The touch-sensitive device as claimed in claim 1, wherein the decorative layer is a shelter layer, a colored layer or a transparent layer.

4. The touch-sensitive device as claim in claim 1, wherein each of the connecting lines comprises at least one of a metallic material, a polymeric conductive material, ITO, IZO, AZO, ZnO and SnO.

5. The touch-sensitive device as claim in claim 1, wherein each of the connecting lines does not cross the contour of the icon.

6. A fabrication method of a touch-sensitive device, comprising:
providing a transparent substrate;
forming a decorative layer on the transparent substrate;
forming a notch on the decorative layer at a position substantially coinciding with a distribution area of an icon; and
forming a plurality of connecting lines that connect transparent electrodes on the transparent substrate, wherein the connecting lines on the decorative layer do not overlap a periphery of the notch.

7. The fabrication method as claimed in claim 6, wherein the decorative layer comprises at least one of diamond like carbon, ceramic, colored ink, resin and photo resist.

8. The fabrication method as claimed in claim 6, wherein the decorative layer is a shelter layer, a colored layer or a transparent layer.

9. The fabrication method as claimed in claim 6, wherein each of the connecting lines comprises at least one of a metallic material, a polymeric conductive material, ITO, IZO, AZO, ZnO and SnO.

10. The fabrication method as claimed in claim 6, wherein each of the connecting lines does not cross the contour of the icon.

11. A fabrication method of a touch-sensitive device, comprising:
providing transparent substrate;
arranging a plurality of connecting lines that connect transparent electrodes in predetermined positions of the transparent substrate;
detecting whether or not the predetermined positions cross the contour of an icon, and labeling a connecting line crossing the contour of the icon as a connecting line to be adjusted; and
moving or rotating the connecting line to be adjusted to prevent all the connecting lines on the transparent substrate from crossing the contour of the icon.

12. The fabrication method as claimed in claim 11, wherein the decorative layer comprises at least one of diamond like carbon, ceramic, colored ink, resin and photo resist.

13. The fabrication method as claimed in claim 11, wherein the decorative layer is a shelter layer, a colored layer or a transparent layer.

14. The fabrication method as claimed in claim 11, wherein each of the connecting lines comprises at least one of a metallic material, a polymeric conductive material, ITO, IZO, AZO, ZnO and SnO.

15. The fabrication method as claimed in claim 11, wherein a first connecting line rotates an angle relative to a second connecting line that crosses the first connecting line to avoid crossing the contour of the icon, and the angle is in the range of 0 degree to 90 degrees.
